(19) United States
(12) Patent Application Publication
(10) Pub. No.: US 2015/0233481 A1
(43) Pub. Date: Aug. 20, 2015

(54) SPOOL VALVE

(71) Applicant: DENSO CORPORATION, Kariya-city (JP)

(72) Inventor: Yasuhiro SHIMURA, Kariya-city (JP)

(21) Appl. No.: 14/616,965

(22) Filed: Feb. 9, 2015

(30) Foreign Application Priority Data
Feb. 15, 2014 (JP) 2014-27075

(51) Int. Cl. F16K 11/07; F16K 99/00; F16K 27/04

(52) U.S. Cl. CPC F16K 11/0716; F16K 27/048; F16K 99/00

(57) ABSTRACT

A spool valve includes a sleeve and a filter. The sleeve includes an annular groove and a port. The annular groove is formed on an outer peripheral surface of the sleeve. The port is formed on a bottom surface of the annular groove, and fluid passes through the port. The filter is disposed to be wound cylindrically in the annular groove, and filters the fluid passing through the port. The sleeve further includes a wound part that is a filter attachment surface on which the filter is wound in the annular groove. The wound part includes a shape change part that changes a shape of a part of the filter having a cylindrical shape.

### CROSS REFERENCE TO RELATED APPLICATION

This application is based on Japanese Patent Application No. 2014-27075 filed on Feb. 15, 2014, the disclosure of which is incorporated herein by reference.

### TECHNICAL FIELD

The present disclosure relates generally to a spool valve including a sleeve with a port formed on a bottom surface of its annular groove. In particular, the present disclosure relates to an attachment technology for a filter which is attached to an inside of the annular groove.

### BACKGROUND

Conventional technologies will be described below. There is known a technology to dispose a filter inside an annular groove of a sleeve in which a port (e.g., inlet port) is formed, to prevent entry of foreign substances into a spool valve (e.g., JP2004-257454A). Various technologies have been proposed for the technology to attach the filter to the inside of the annular groove. As a specific example, there are known technologies for fitting by an abutment joint (e.g., S-shaped abutment joint) a cylindrical filter (cylindrical frame body with a mesh structure at its window part) made of resin divided into two parts, and for winding a belt-like filter component around an annular groove and then fixing the component by a snap ring or the like.

These conventional technologies have defects which cause increase in process cost, increase in the number of components, and increase in man-hours for attachment and which bring about increase in manufacturing cost. Accordingly, there is proposed a technology for winding a belt-like member having a shape of a thin plate with many fine pores inside the annular groove and for joining together overlapping parts of the belt-like member by laser welding or the like.

However, the above-described technology has the following issues. The filter obtained by winding the thin plate-shaped belt-like member having many fine pores around the annular groove and by cylindrically joining the belt-like member has weakened binding force for the annular groove. Therefore, the cylindrical filter is easy rotated under the influence of a flow of fluid (e.g., oil) flowing through the port, and there is a concern that wear is caused at a sliding part between the sleeve and the filter.

For this reason, there is proposed a technology whereby a protruding portion or engagement groove is formed at the annular groove of the sleeve, and a part of the filter is fitted to the protruding portion or engagement groove to prevent the rotation of the filter. Nevertheless, high working accuracy is required to provide the protruding portion or engagement groove for the annular groove. Accordingly, this leads to increase in processing cost, and a fitting process for fitting the filter to the protruding portion or engagement groove needs to be added. In addition, there is also proposed a technology whereby a part with a large groove width and a part with a small groove width are provided for the annular groove, and the width of the belt-like member is changed in accordance with a change of the groove width. However, there arises an issue that, due to the change of the groove width, significant increase in processing cost is caused, and furthermore a sealing distance to the adjacent other annular groove is partly shortened, so that a sealing length cannot be ensured.

### SUMMARY

The present disclosure addresses at least one of the above issues. Thus, it is an objective of the present disclosure to provide a spool valve that can prevent at low cost rotation of a filter which is wound around an annular groove.

To achieve the objective of the present disclosure, there is provided a spool valve including a sleeve and a filter. The sleeve includes an annular groove and a port. The annular groove is formed on an outer peripheral surface of the sleeve. The port is formed on a bottom surface of the annular groove, and fluid passes through the port. The filter is disposed to be wound cylindrically in the annular groove, and filters the fluid passing through the port. The sleeve further includes a wound part that is a filter attachment surface on which the filter is wound in the annular groove. The wound part includes a shape change part that changes a shape of a part of the filter having a cylindrical shape.

### BRIEF DESCRIPTION OF THE DRAWINGS

The above and other objects, features and advantages of the present disclosure will become more apparent from the following detailed description made with reference to the accompanying drawings. In the drawings:

FIG. 1 is an external view illustrating an oil control valve (OCV) in accordance with an embodiment;

FIG. 2 is a cross-sectional view taken along a line II-II in FIG. 1;

FIG. 3A is a perspective view illustrating the OCV to which a filter is attached according to the embodiment;

FIG. 3B is a perspective view illustrating the OCV to which the filter is not attached according to the embodiment; and

FIG. 4 is a schematic view illustrating a variable valve timing mechanism (VVT) according to the embodiment.

### DETAILED DESCRIPTION

An embodiment will be described in detail below with reference to the drawings.

The embodiment described below is a specific example of the present disclosure, and it goes without saying that the present disclosure is not limited to the embodiment.

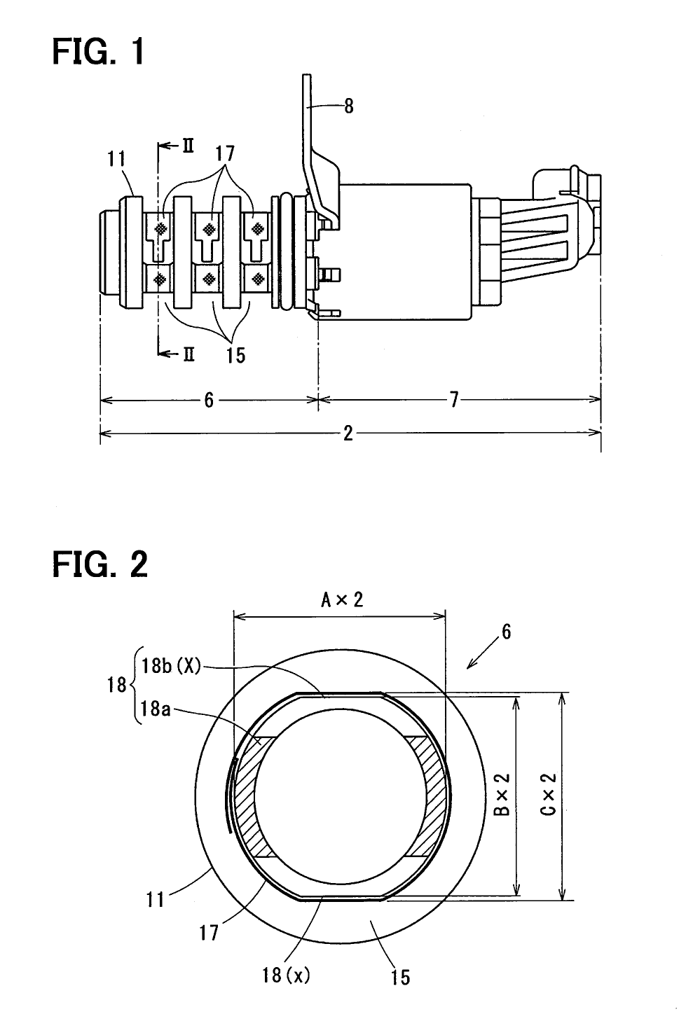

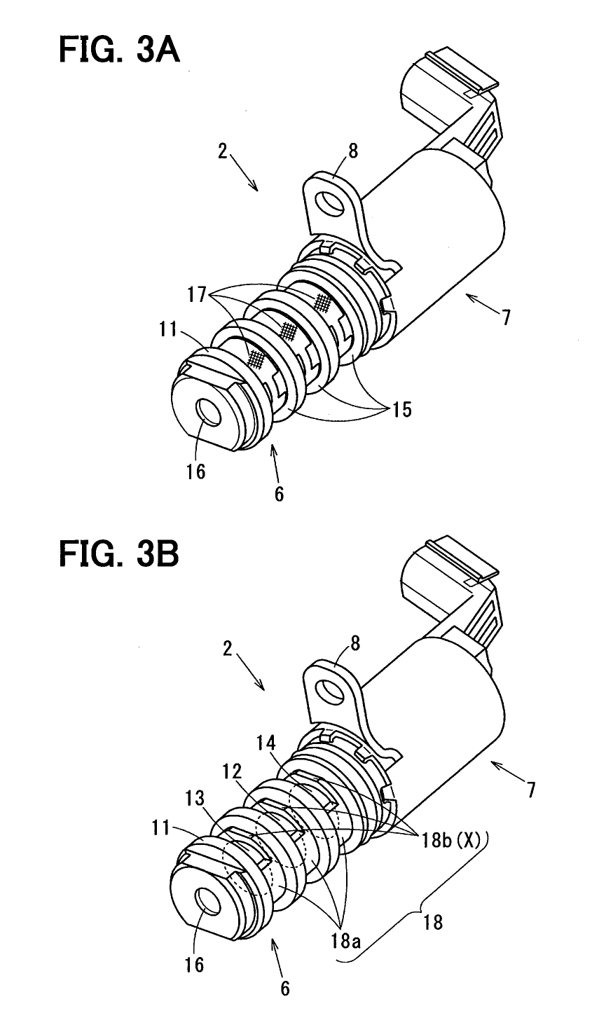

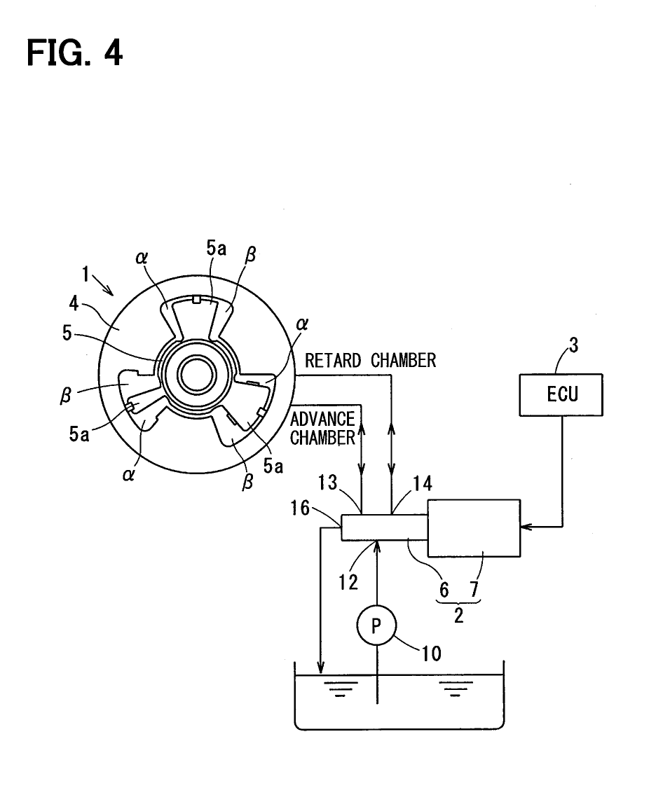

The embodiment will be explained in reference to FIGS. 1 to 4. A variable valve timing mechanism (VVT) includes a hydraulic variable camshaft timing mechanism (VCT) 1 that can vary opening or closing timing of a valve by varying an advanced amount of a camshaft of an engine, an oil control valve (OCV) 2 for controlling oil pressure of an advance chamber α and a retard chamber β in this VCT 1, and an engine control unit (ECU) 3 that electrically controls the operation of this OCV2.

The VCT 1 will be described below. The VCT 1 includes a shoe housing 4 that is rotated in synchronization with a crankshaft of the engine, and a vane rotor 5 that rotates integrally with the camshaft, and rotates the vane rotor 5 relative to the shoe housing 4 to change the camshaft to an advance side or to a retard side.

The vane rotor 5 is provided to be rotatable relative to the shoe housing 4 within a predetermined angle, and the vane rotor 5 includes a vane 5a that divides an internal space in the shoe housing 4 between the advance chamber α and the retard chamber β. The advance chamber α and the retard chamber β are oil pressure chambers for driving the vane 5a to the advance side or to the retard side.

The OCV 2 will be described below. The OCV 2 is an electromagnetic spool valve 2 that is obtained by joining together in the axial direction a spool valve 6 having a four-way valve structure, and an electromagnetic actuator (linear solenoid) 7 that drives this spool valve 6. The spool valve 6 is inserted into an OCV attachment hole (hole whose inner peripheral surface has a cylindrical shape) formed at an engine component (e.g., cylinder head), and a stay 8 provided for the electromagnetic actuator 7 is fixed to the engine component.

The spool valve 6 includes a sleeve 11 that is inserted in the OCV attachment hole provided for the engine component, a spool (slide valve body) that is slidably supported in this sleeve 11 in the axial direction to adjust a communicating state of each port, and a return spring that urges this spool toward the electromagnetic actuator 7.

The sleeve 11 has a generally cylindrical shape, and its outer peripheral surface is inserted and disposed in the OCV attachment hole with a minute clearance therebetween. A sliding hole for slidably supporting the spool in the axial direction is formed in this sleeve 11. The spool for switching a flow passage or for adjusting an opening degree of the flow passage is slidably supported by an inner peripheral surface of this sliding hole.

The sleeve 11 includes input and output ports. Specifically, in the radial direction of the sleeve 11, there are provided an input port 12 to which operating oil discharged from an oil pump 10 is supplied, an advance port 13 communicating with the advance chamber α, and a retard port 14 communicating with the retard chamber β. These ports in the radial direction are arranged in order of the advance port 13, the input port 12, and the retard port 14 from a leading end of the sleeve 11 toward the electromagnetic actuator 7.

To explain more specifically, the radial ports (advance port 13, input port 12, and retard port 14) are provided respectively on bottom surfaces of annular grooves 15 which are formed independently in the axial direction on an outer peripheral surface of the sleeve 11. The annular groove 15 can guide the oil annularly, and is for reliably making a communication between an oil passage (e.g., oil passage in the cylinder head) formed in the engine component and its corresponding radial port and for limiting flow passage resistance at the time of delivery or receipt of oil.

On the other hand, a drain port 16 that communicates with a drain space (space communicating with a drain pan) is provided at the leading end of the sleeve 11 (end on a different side from the electromagnetic actuator 7).

The spool has a generally cylindrical shape (not limited to this shape), and its outer peripheral surface is inserted and disposed in the sleeve 11 via a minute clearance relative to an inner peripheral surface of the sleeve 11. The spool is displaced slidingly in the axial direction by driving force of the electromagnetic actuator 7 to change a switching state or communicating degree of each port according to the slide position. Accordingly, there are achieved a retard state (state in which the camshaft is driven to the retard side), a hold state (state in which the advanced amount of the camshaft is held), and an advance state (state in which the camshaft is driven to the advance side).

The characteristic technology of the embodiment will be described below. As explained above, oil is supplied to the input port 12 from the oil pump 10. The oil suctioned into the oil pump 10 is filtered through an element. However, there is a concern that foreign substances (e.g., deposits produced by the accumulation of flaked-off burr or impurities) produced during the supply of oil may be led into the input port 12 together with oil. There is fear that the entry of such foreign substances into the spool valve 6 may inhibit the slidability of the spool. Accordingly, for the purpose of preventing the entry of foreign substances into this input port 12 of the spool valve 6, a filter 17 is provided in the annular groove 15 at which the input port 12 is formed.

Return oil which is returned from the advance chamber α and the retard chamber β is supplied to the advance port 13 and the retard port 14. As for the return oil, there is a concern that the foreign substances (e.g., deposits produced by the accumulation of flaked-off burr or impurities) produced in the VCT 1 and along the oil passage may be led into the advance port 13 and the retard port 14 together with the oil. There is fear that the entry of such foreign substances into the spool valve 6 may inhibit the slidability of the spool. Accordingly, for the purpose of preventing the entry of foreign substances into the advance port 13 and the retard port 14 of the spool valve 6, the filters 17 are provided respectively in the annular grooves 15 at which the advance port 13 and the retard port 14 are formed.

Each filter 17 is disposed to be wound cylindrically in the annular groove 15, and, as described above, filters the oil flowing through its corresponding port (input port 12, advance port 13, retard port 14). The filter 17 is obtained by winding a belt-like member having a shape of a thin plate with many fine pores inside the annular groove 15 and by joining together overlapping parts of the belt-like member by laser welding or the like. As a specific example, the belt-like member is made of a thin plate of metal (e.g., stainless steel) excellent in corrosion resistance. To explain more specifically, the belt-like member is formed by means of a “cutting technique” and an “etching technique” (one example, and not limited to these techniques); an outer diameter shape of the belt-like member is provided by the “cutting technique”; and many small through holes for filtering are provided by the “etching technique”.

A belt (filter) attachment surface on which the filter 17 is wound in the annular groove 15 is referred to as a wound part 18. In this embodiment, it is illustrated that the wound part 18 serves as a bottom surface of the annular groove 15 on which each port (input port 12, advance port 13, retard port 14) is formed. Alternatively, unlike this embodiment, the bottom surface on which the port is formed may be provided to have a smaller diameter than the wound part 18.

In this embodiment, a shape change part X for changing a shape of a part of the filter 17 into a non-circular shape is provided for a part of the wound part 18 on which the filter 17 is wound. Specifically, the wound part 18 of this embodiment includes a cylindrical part 18a and a reduced diameter part 18b that is smaller than a radius of this cylindrical part 18a. As illustrated in FIG. 2, this reduced diameter part 18b is a straight-line portion that is formed by cutting a part of the cylindrical part 18a, and the shape change part X is provided by the reduced diameter part 18b.

To explain more specifically, when the radius of the cylindrical part 18a is A; the minimum radius of the reduced diameter part 18b is B; and the minimum radius of the filter 17 wound on the reduced diameter part 18b is C, the shape change part X is provided to satisfy a relationship of (radius A of the cylindrical part 18a)>(minimum radius C of the filter 17).

As for the specific attachment of the filter 17, the belt-like member is wound around the wound part 18, and the overlapping parts of the belt-like member are joined together by spot welding or the like with tension (tensile force) applied in a direction in which the overlapping parts of the belt-like member become large. As a result, the filter 17 is attached along a shape of the wound part 18. Thus, the belt-like member made of a thin plate configured as the filter 17 is attached in a deformed state along the shape of the wound part 18, and is provided to satisfy the relationship of (radius A of the cylindrical part 18a)>(minimum radius C of the filter 17).

Effects of the characteristic technology will be described below. In the spool valve 6 of this embodiment, as explained above, there is employed such a configuration that the shape change part X (straight linear reduced diameter part 18b) is provided for the wound part 18, and a part of the filter 17 is deformed to have a non-circular shape by this shape change part X. Specifically, the wound part 18 has a non-circular shape by the shape change part X, and the filter 17 wound on the non-circular wound part 18 also has a non-circular shape along the non-circular wound part 18. To explain more specifically, the relationship of (radius A of the cylindrical part 18a)>(minimum radius C of the filter 17) is satisfied. Accordingly, the non-circular filter 17 is not rotatable relative to the non-circular wound part 18, and the rotation of the filter 17 can thereby be prevented.

The shape change part X is for making non-circular the wound part 18 and does not require high working accuracy. Specifically, the shape change part X is the straight linear reduced diameter part 18b that is formed by cutting a part of the cylindrical part 18a, and functions sufficiently despite its preparation with low working accuracy. Specifically, even if the minimum radius B of the reduced diameter part 18b (see “B×2” in FIG. 2) varies to a certain extent, the rotation of the filter 17 can be prevented. Moreover, the filter 17 which is wound around the annular groove 15 does not need to be worked for preventing the rotation. In addition, attachment of the filter 17 is carried out only by winding the filter 17 around the annular groove 15 and joining together the overlapping parts. Accordingly, the filter 17 can be attached similar to the conventional technology, and a special attachment process (e.g., fitting process) for the prevention of rotation is unnecessary.

As described above, the rotation of the filter 17 can be prevented only by providing the shape change part X for the wound part 18. Consequently, the cost of the OCV 2 including the filters 17 with the rotation prevention can be curbed. Therefore, the OCV 2 which does not produce wear due to the rotation of the filter 17 can be provided at low cost, and as a result, reliability of the VVT can be improved at low cost. Industrial applicability of the spool valve 6 of this embodiment will be described below.

As a specific example, it is illustrated in FIG. 2 that the two shape change parts X (reduced diameter parts 18b in the embodiment) are provided for the one wound part 18. Alternatively, similar effects can be produced also by one shape change part X1 that is provided for the one wound part 18.

In the above-described embodiment, it is illustrated that the shape change part X is configured as the straight linear reduced diameter part 18b. However, the shape of the shape change part is not limited to the above, and the shape change part X may be configured as a recessed part, or may be configured as a projecting part. As a matter of course, in the case of the shape change part X configured as a projecting part, the wound filter 17 is accommodated inside the annular groove 15, and the filter 17 does not swell out of the annular groove 15.

In the above embodiment, it is illustrated that only the filter 17 is formed from the belt-like member. Alternatively, for example, in a case of the belt-like member disposed at the annular groove 15, in which the input port 12 is formed, a “belt part serving as the filter 17” and a “belt part serving as a reed valve” may be provided by one continuous sheet of a belt-like member.

In the above embodiment, the example of application of the present disclosure to the OCV 2 of the WT is described. Alternatively, the present disclosure may be applied to a spool valve 6 for other uses different from the VVT. Specifically, the present disclosure may be applied not only to the spool valve 6 having a four-way valve structure but also to another spool valve 6 such as a spool valve 6 having a three-way valve structure. Furthermore, the present disclosure may be applied to a spool valve 6 for other uses such as a spool valve 6 used for a hydraulic control system of an automatic transmission. Additionally, a means for driving the spool valve 6 is not limited to the electromagnetic actuator 7, and the spool may be driven by another driving source.

To sum up, the spool valve 6 in accordance with the above embodiment can be described as follows.

In the spool valve 6 of the present embodiment, the shape change part X (e.g., swelling, recess, or straight-line portion) is provided for the wound part 18 in the annular groove 15 (part on which the filter 17 is wound inside the annular groove 15), and a shape of a part of the cylindrical filter 17 is changed by this shape change part X. Because the wound part 18 has a non-circular shape by the shape change part X, the filter 17 wound on the non-circular wound part 18 also has a non-circular shape along the non-circular wound part 18. Accordingly, the non-circular filter 17 is not rotatable relative to the non-circular wound part 18, and the rotation of the filter 17 can thereby be prevented.

The shape change part X is for making non-circular the wound part 18 and does not require high working accuracy. Moreover, the filter 17 which is wound around the annular groove 15 does not need to be worked for preventing the rotation. In addition, attachment of the filter 17 is carried out only by winding the filter 17 around the annular groove 15 and joining together the overlapping parts. Thus, a process (e.g., fitting process) for the rotation prevention is not necessary at the time of attachment of the filter 17. In this manner, as a result of the present embodiment, the rotation of the filter 17 which is wound around the annular groove 15 can be prevented at low cost. Obviously, groove width of the annular groove 15 does not need to be changed, and such a defect that the sealing length cannot be ensured is not caused.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A spool valve comprising:
a sleeve that includes:
an annular groove formed on an outer peripheral surface of the sleeve; and
a port which is formed on a bottom surface of the annular groove and through which fluid passes; and
a filter that is disposed to be wound cylindrically in the annular groove and that filters the fluid passing through the port, wherein:
the sleeve further includes a wound part that is a filter attachment surface on which the filter is wound in the annular groove; and
the wound part includes a shape change part that changes a shape of a part of the filter having a cylindrical shape.

2. The spool valve according to claim 1, wherein:
the wound part includes a cylindrical part, and a reduced diameter part that is smaller than a radius of the cylindrical part;
the reduced diameter part serves as the shape change part; and
the shape change part is provided to satisfy a relationship of A>C where:
A is a radius of the cylindrical part; and
C is a minimum radius of the filter wound on the reduced diameter part.

3. The spool valve according to claim 1, wherein the wound part is the bottom surface of the annular groove.

4. The spool valve according to claim 1, wherein the spool valve is combined with an electromagnetic actuator to constitute an electromagnetic spool valve.

5. The spool valve according to claim 1, wherein the spool valve is used for an oil control valve (OCV) that controls operating oil pressure of a variable camshaft timing mechanism (VCT) which is capable of varying an advanced amount of a camshaft of an engine.
